(19) United States
(12) Patent Application Publication
(10) Pub. No.: US 2015/0207793 A1
(43) Pub. Date: Jul. 23, 2015

(54) Feature Enablement or Disablement Based on Discovery Message

(71) Applicants: Parvez Syed Mohamed, Folsom, CA (US); Shaun Wakumoto, Roseville, CA (US)

(72) Inventors: Parvez Syed Mohamed, Folsom, CA (US); Shaun Wakumoto, Roseville, CA (US)

(21) Appl. No.: 14/417,066

(22) PCT Filed: Jul. 31, 2012
(86) PCT No.: PCT/US2012/049053

§ 371 Date: Jan. 23, 2015

(51) Int. Cl. H04L 29/06; H04L 12/24

(52) U.S. Cl. CPC H04L 63/0876; H04L 63/02; H04L 41/12

(57) ABSTRACT

Example embodiments disclosed herein relate to a discovery message, the discovery message including information related to an attribute of a port of a network device sending the discovery message. A determination is made whether to enable/disable a feature at a port of the network device based on the information related to the attribute of a port of the network device and a port of a neighbor network device.

### BACKGROUND

In networking technology, there are various types of packets transmitted between source and destination devices through network devices, for example, switches, routers, etc. These packets can be transmitted in accordance with one or more specifications and/or standards. For example, many routers and switches today are compatible with one or more specifications or standards, like IEEE 802.3. As technology advances, additional standards are being implemented to provide additional features to the network. For example, standards like IEEE 802.1AE defining the IEEE Media Access Control (MAC) Security standard (MACsec), 802.1X defining the Extensible Authentication Protocol (EAP) over IEEE 802, etc., are being added. These standards may, for example, provide additional security at ports of network devices to the data being transmitted within the network.

### BRIEF DESCRIPTION OF THE DRAWINGS

The following detailed description references the drawings, herein:

FIG. 1 is a block diagram of a network device according to one or more examples of the present disclosure;

FIG. 2 is a discovery message, according to one or more examples of the present disclosure;

FIG. 3 is a block diagram of a system including two network devices, according to one or more examples of the present disclosure;

FIG. 4 is a flow diagram of a process to determine whether to enable a feature, according to one or more examples of the present disclosure;

FIG. 5 is a block diagram of a system including three network devices, according to one or more examples of the present disclosure;

FIG. 6 is a flow diagram of a process to enable a pass through feature, according to one or more examples of the present disclosure;

FIG. 7 is a block diagram of a system including several network devices, according to one or more examples of the present disclosure;

FIG. 8 is a block diagram of a system including a pass through switch capable of passing frames based on an Ethertype, according to one or more examples of the present disclosure;

FIGS. 9A and 9B are block diagrams of network devices capable of passing through frames based on an Ethertype associated with the respective frames, according to one or more examples of the present disclosure; and

FIG. 10 is a flowchart of a method for forwarding a frame based on an Ethertype, according to one or more examples of the present disclosure.

### DETAILED DESCRIPTION

In order to implement features within a network, network devices may be configured by an administrator. However, this configuration process may be time-consuming and require direct attention by the administrator to ensure the network device is properly configured to process data in conformity with the standards.

As discussed herein, in at least one embodiment, a discovery message may be used to communicate information related to one or more attributes of a feature of a network device. A network device receiving the discovery message may parse the message for the information related to the one or more attributes of a neighbor network device. Based on the information related to one or more attributes from the discovery message, the network device may enable or disable a feature.

By including information related to one or more attributes in the discovery message, little, if any, attention is needed by the administrator in order to enable or disable a feature at the network device.

In at least another embodiment, a network device may enable or disable a pass through feature and provide secure communication between neighboring network devices based on information included in discovery messages.

Examples as discussed herein provide for enablement of a feature based on one or more attributes in a discovery message. It may be appreciated that the devices, systems and processes herein may similarly disable a feature based on one or more attributes in a discovery message.

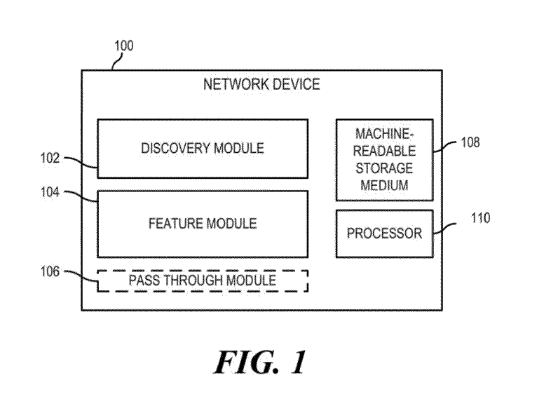

FIG. 1 depicts an example network device 100. Network device 100 may be implemented as a switch, router, bridge, or any other type of wired network device. As shown in FIG. 1, network device 100 may include discovery module 102, feature module 104, machine readable storage medium, or computer readable storage medium, 108, processor 110 and pass through module 106. Network device 100 may further include one or more neighbor network device tables on a per port basis (not shown in FIG. 1). The one or more neighbor network device tables may include information related to the neighbor network device that is connected to a port of the network device. It may be appreciated that network device 100 may further include additional components to facilitate switching functions routing functions, etc.

Discovery module 102 may be implemented as machine readable instructions stored on a computer readable storage medium 108, which may be non-transitory, such as hardware storage devices (e.g., RAM (random access memory), ROM (read only memory), EPROM (erasable, programmable ROM), EEPROM (electrically erasable, programmable ROM), hard drives, and flash memory). The machine readable instructions may be executable by a processor to perform the functionality as discussed herein.

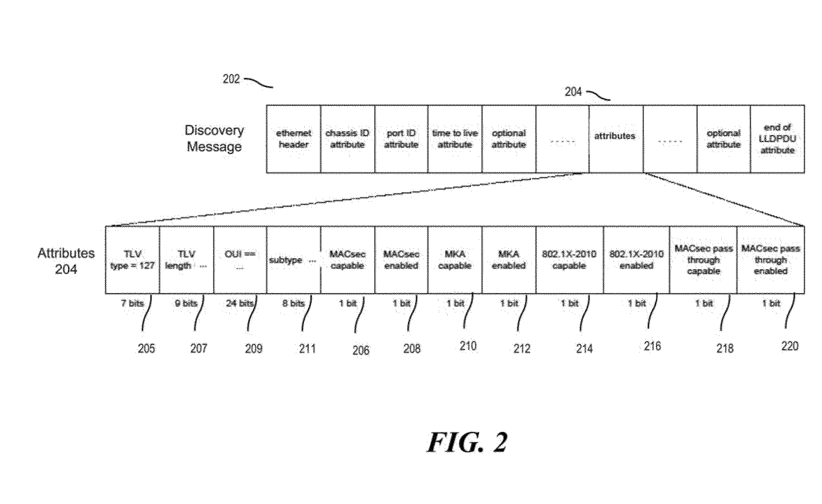

Discovery module 102 may generate, transmit, receive, and process discovery messages between a port of the network device 100 and ports of other network devices within a network. In generating a discovery message, the discovery module may access information related to one or more attributes of the port of the network device 100 transmitting the discovery message. The attributes may relate to one or more features of the port of the network device. For example, features of the network device may include IEEE 802.1AE defining the IEEE Media Access Control (MAC) Security standard (MACsec), 802.1X defining the Extensible Authentication Protocol (EAP) over IEEE 802, MACsec Key Agreement (MKA), etc. Attributes related to the feature may include, for example, capability of the network device enabling the feature, state of enablement of the feature on the network device, etc. Information related to the attributes may be information indicating the state of the attribute with respect to the network device, for example, that the network device is capable of enabling a feature, that the feature is enabled, etc. The content of the discovery message will be discussed in more detail with respect to FIG. 2.

The discovery module 102 may transmit the discovery message, including the information related to the one or more attributes, to one or more neighbor network devices. The discovery message may be transmitted in accordance with a discovery protocol.

The discovery module 102 may further receive discovery messages from one or more neighbor network devices, Upon receipt of a discovery message, the discovery module 102 may process the received message. Processing may include parsing the received message and extracting information related to attributes of the port of the neighbor network device that the network device is connected to. This extracted information may be stored in a neighbor network table.

The discovery module 102 may further process the received message by determining whether to enable or disable a port-based feature based on information extracted from the discovery message. A feature may be enabled, for example, when the discovery module compares the information related to the attribute of the port of neighbor network device, for example, as stored in the neighbor network device table, with information related to attributes of the port of the network device itself. If both the network device 100 and the neighbor network device are capable of enabling the same feature, the discovery module 102 may initiate enablement of the feature at the network device 100. A feature may be disabled, for example, when the discovery module compares the information related to the attribute of the port of neighbor network device, for example, as stored in the neighbor network device table, with information related to attributes of the port of the network device itself. If one of the network device 100 and the neighbor network device are not capable of enabling the same feature, the discovery module 102 may initiate disablement of the feature at the network device 100.

Discovery messages as discussed herein may be generated in accordance with discovery protocols for transmitting network device information to neighboring network devices. For example, discovery messages may be generated in accordance with link layer discovery protocol (LLDP), Cisco Discover Protocol (CDP), Extreme Networks Discovery Protocol (ENDP), etc. It may be appreciated that a discovery protocol that is extendable to permit configuration to include information related to attributes as discussed herein may be utilized, Examples as discussed herein are discussed with respect to LLDP.

It may further be appreciated that a physical layer device (PHY) communication exchange, for example, Energy Efficient Ethernet (EEE), port speed, duplex negotiation, etc., may be utilized to communicate information regarding a network device to a neighboring network device. EEE utilize physical layer devices (PHYs) to communicate information about the port of network device to neighboring devices. These PHY communication exchanges may be configured to additionally include information related to attributes of the port of the network device as more fully discussed herein.

Network device 100 may further include feature module 104. Feature module 104 may be implemented in hardware, software, or firmware. It may be appreciated that feature module 104 may check to determine if a feature is capable of being enabled or disabled, is enabled or disabled, etc. In addition, a plurality of modes may be provided, for example, an explicit enable, and explicit disable, an automatic mode, etc. The explicit enable may provide that a feature is always enabled, an explicit disable may provide that the feature is always disabled, and an automatic mode may automatically enable or disable the feature based on the processes discussed herein.

Feature module 106 may receive an indication from discovery module 102 to enable a feature. Feature module 106 may be implemented as machine readable instructions stored on a computer readable storage medium 108, which may be non-transitory, such as hardware storage devices (e.g., RAM (random access memory), ROM (read only memory), EPROM (erasable, programmable ROM), EEPROM (electrically erasable, programmable ROM), hard drives, and flash memory). The machine readable instructions may be executable by a processor to perform the functionality as discussed herein. Alternatively, feature module 106 may be implemented in hardware in order to enable a feature. For example, where the feature may be MACsec, the discovery module may initiate enablement of MACsec in hardware.

Network device 100 may further include a processor 108, for example a central processing unit or microprocessor, that may retrieve and implement or execute machine readable instructions and/or electronic circuits to perform the functionality of the modules and the processes as discussed herein. Commands and data from the processor 108 may be communicated over a communication bus (not shown). The network device may also include a main memory (not shown), such as a random access memory (RAM), where the machine readable instructions and data for the processor 108 may reside during runtime, and a secondary data storage (not shown), which may be non-volatile and stores machine readable instructions and data. The memory and data storage are examples of computer readable storage mediums. The memory may include modules as discussed herein including machine readable instructions residing in the memory during runtime and executed by the processor 108. The processor 108 may also be a special purpose networking processor. Moreover, in certain embodiments, some components can be utilized to implement functionality of other components described herein.

Network device 100 may optionally include pass through module 106. Pass through module 106 may implement a pass through feature that enables two neighboring devices of network device 100 to communicate securely as more fully discussed below.

FIG. 2 depicts an example structure of a discovery message 202 using LLDP. As shown in FIG. 2, discovery message 202 includes a plurality of fields related to the port of the network device, the discovery message 202 configured in accordance with LLDP. In addition, discovery message 202 includes attributes 204. Attributes 204 may be implemented as a plurality of fields including information related to attributes of one or more features of the port of the network device 100 In the example depicted in FIG. 2, attributes 204 includes
type-length-value field 205 indicating custom fields outside the standard LLDP fields;
type-length-value field 207 indicating length of the custom fields;
organizationally unique identifier field 209;
organizationally defined subtype field 211;
MACsec capability field 206, and is populated with an indication that the port of the network device 100 is capable of the MACsec feature;
MACsec enablement state field 208, and is populated with are indication that the port of the network device 100 is MACsec enabled;
MKA capability field 210, and is populated with an indication that the port of the network device 100 is capable of the MKA feature:
MKA enablement state field 212, and is populated with an indication that port of the network device 100 is MKA enabled;
802.1X-2010 capability field 214, and is populated with an indication that the port of the network device 100 is capable of the 802.1X-2-1-feature;
802.1X-2010 enablement state field 216, and is populated with an indication that the port of the network device 100 is 802.1X-2010 enabled;
MACsec pass through capability field 218, and is populated with au indication that the port of the network device 100 is capable of the MACsec pass through feature; and
MACsec pass through enablement state field 220, and is populated with an indication that port of the network device 100 is MACsec pass through disabled.

It may be appreciated that more or less fields in the attributes 204 fields may be included in the discovery message. The number of attributes 204 fields may depend on the number of features available at the port of the network device to communicate to neighbor network devices.

As can be seen in FIG. 2, based on the customization of the discovery message, information regarding a feature that the network device may or may not enable at its port, together with the state of enablement, may be transmitted to neighbor network devices.

In an example directed to utilizing a PHY communication exchange discovery message, for example, EEE, duplex, and port speed capabilities, the PHY communication exchange discovery message may include attributes 204.

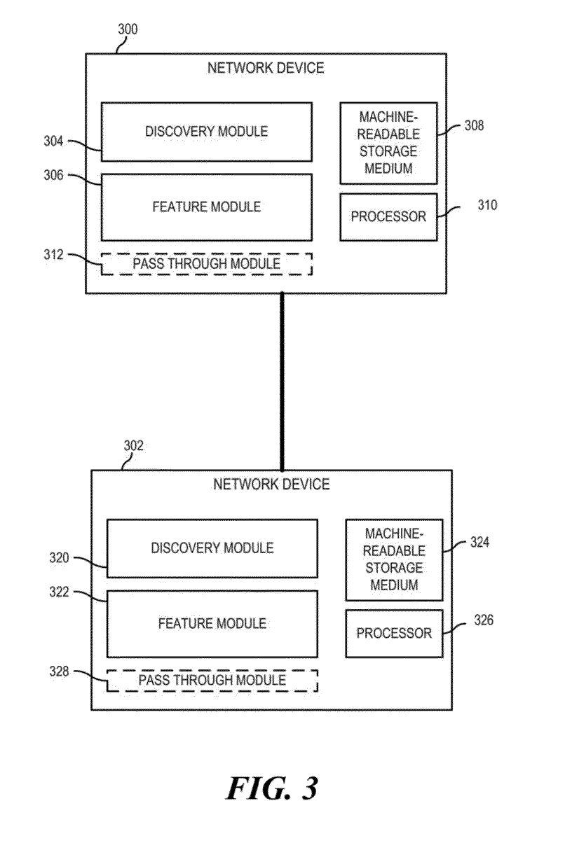

FIG. 3 depicts an example system including two network devices 300 and 302, Network device 300 may include discovery module 304, feature module 306, machine readable storage medium 308, processor 310 and optionally pass through module 312. Network device 302 may include discovery module 320, feature module 322, machine readable storage medium 324, processor 326 and optionally pass through module 328. Network devices 300 and 302 may be implemented similarly to the network device as discussed with regard to FIG. 1.

It may be appreciated that network devices 300 and 302 may communicate within a wired networked environment. Further, the networked environment can include multiple sub communication networks such as data networks, telephony networks, etc. Such networks can include, for example, a public data network such as the Internet, local area networks (LANs), wide area networks (WANs), metropolitan area networks (MANs), cable networks, fiber optic networks, combinations thereof, or the like. Various communications structures and infrastructure can be utilized to implement the networked environment.

In the example where the discovery message is generated accordance with PHY communication exchange, network devices 300 and 302 may utilize a PHY connected to a port to generate and transmit the discovery message with the information related to one or more attributes of the network device. Network devices 300 and 302, upon receipt of a discovery message at a port, may process the discovery message at the PHY connected to the port, extract the information associated to the one or more attributes of the neighbor network device, and pass the extracted information to a processor, where the discovery module may compare the extracted information to determine whether to enable a feature, as discussed herein.

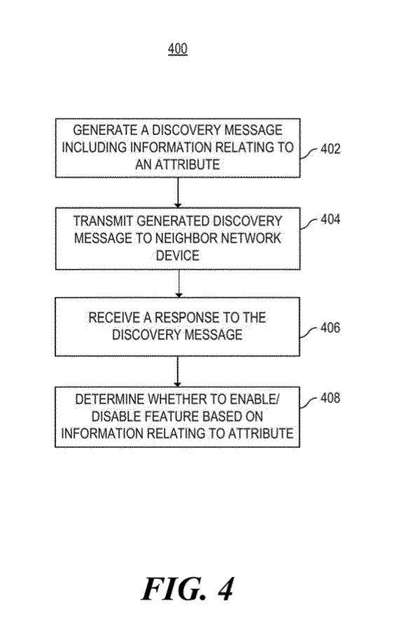

FIG. 4 depicts a flow diagram of a process 400 performed by a network device. For example, the process depicted in FIG. 4 may be performed by network device 100, 300 or 302. As shown in FIG. 4, a discovery message may be generated 402. The discovery message may include information relating to one or more attributes of the port of the network device sending the discovery message. For example, if the port of the network device has the capability to enable 802.1X, when generating a discovery message, attributes related to the 8021X feature may be included in the generated message. These attributes may include whether the port is capable of enabling 802.1X, the state of enablement of 802.1x, etc.

The network device may transmit the generated discovery message to one or more neighbor network devices 404. The network device may then receive a response to the discovery message 406 from the neighbor network device. The response to the discovery message may include information related to one or more attributes of the port of the neighbor network device that the network device is connected to. When the network device receives a response to the discovery message from the port of the neighbor network device, the network device may parse the received response, to extract information associated with attributes of the port of the neighbor network device, for example, whether the port is capable of enabling 802.1X, the state of enablement of 802.1x, etc.

The network device may determine whether to enable or disable a feature at the port of the network device based on the information related to the attribute in the received response from the neighbor network device 408. For example, if the network device determines that the port of the network device and the port of the neighbor network device are both capable of enabling the 802.1X feature, the network device may automatically enable the 802.1X feature. For another example. if the network device determines that either the port of the network device or the port of the neighbor network device are not capable of enabling the 802.1X feature, the network device may not automatically enable the 802.1X feature, or may disable the feature if the feature is enabled. Thus, no assistance from a network administrator is needed, and there is no need to incur downtime at the network device in order to enable the 802.1X feature.

Similarly, the neighbor network device, upon receipt of the generated discovery message may determine that the port of the network device and the port at the neighbor network device are capable of enabling the same feature and thus, may enable the feature prior to, or after, transmission of the response.

Once the feature, for example, 802.1X, is enabled at both the port of the network device and the port of the neighbor network device, network devices 300 and 302 may conduct 802.1X authentication to validate that the network devices 300 and 302 have valid credentials and/or is allowed to communicate. After a successful authentication, 802.1X can also be used to perform a MACsec Key Agreement (MKA) negotiation between network device 300 and 302 to obtain symmetric keys used for MACsec encryption of their secure channel between the respective ports. The network device may transmit communications to the neighbor network device securely based on the enabled security feature(s).

It may be appreciated that other features, as noted above may be enabled based on the determination from the information extracted from the response, for example, MKA, MACsec, etc.

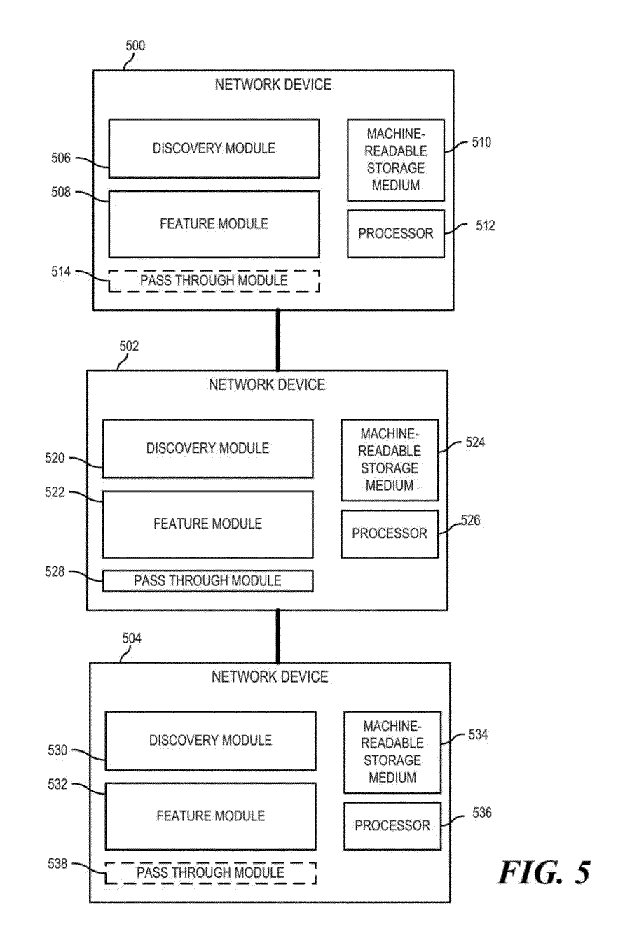

FIG. 5 depicts are example system including three network devices 500, 502 and 504, in accordance with at least one example of the present disclosure. As shown in FIG. 5, network device 500 may include discovery module 506, feature module 508, machine readable storage medium 510, processor 512 and optionally pass through module 514. Network device 502 may include discovery module 520, feature module 522, machine readable storage medium 524, processor 526 and pass through module 528. Network device 504 may include discovery module 530, feature module 532, machine readable storage medium 534, processor 536 and optionally pass through module 538. Network devices 500, 502 and 504 may be implemented similarly to the network device as discussed with regard to FIG. 1.

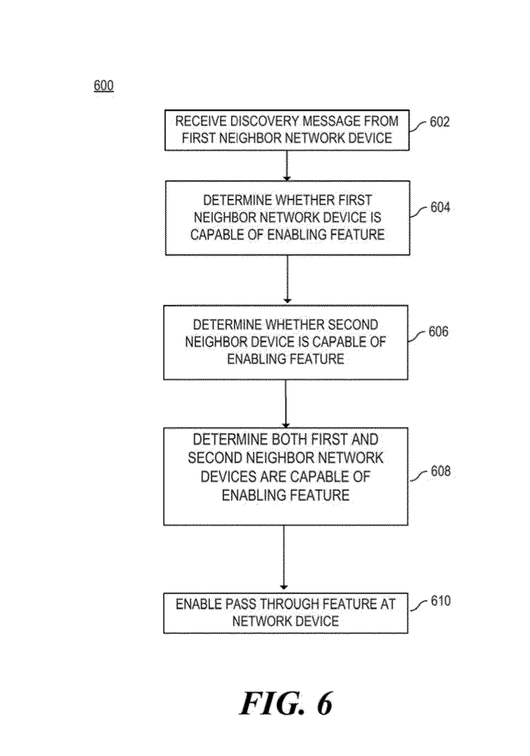

FIG. 6 depicts a flow diagram of a process 600 performed by a network device. For example, the process depicted in FIG. 6 may be performed by network device 100 (where the device includes the pass through module), 500, 502 and 504. For the purposes of explanation, the process will be described as being performed by device 502 in FIG. 5.

As shown in FIG. 6, a discovery message may be received from a first neighbor device 602. In this example, the first neighbor device may be device 500 in FIG. 5. A determination may be made whether the port of the first neighbor device is capable of enabling a feature 604. For example, the network device 502 may determine whether the port of the neighbor network device 500 is capable of enabling MACsec. This determination may be made by parsing the received discovery message and extracting information related to a MACsec attribute from the discovery message.

A determination may be made whether a port of a second neighbor device is capable of enabling the feature 606. For example, network device 502 may determine whether a port of neighbor network device 504 is capable of enabling MACsec. This determination may be made, for example, by checking a neighbor network device table stored at the network device, by transmitting a generated discovery message to the second neighbor network device, receiving a response to the discovery message, parsing the received response and extracting information related to the attribute of the feature, etc.

A determination may be made that the ports of both the first and second neighbor network devices, to which the network device is connected, are capable of enabling the feature 608. For example. network device 602 may compare the information related to the attribute of the port of the first neighbor network device with the determined information related to the attribute of the port of the second neighbor network device. Based on the comparison, the network device may determine that the port of both the first and second neighbor network device are capable of enabling MACsec.

A pass through feature may be enabled at the network device based on the determination that the ports of both the first and second network devices are capable of enabling the feature 610. For example, network device 502 may enable a pass through feature at network device 502 thereby permitting secure communication between the ports of the first neighbor network device 500 and the second neighbor network device 504. The pass through feature is more fully discussed below.

Once the pass through feature is enabled at network device 502, network devices 500 and 504 may conduct 802.1X authentication to validate that the network devices 500 and 504 have valid credentials and/or is allowed to communicate. After a successful authentication, 802.1X can also be used to perform a MACsec Key Agreement (MKA) negotiation between network device 500 and 504 to obtain symmetric keys used for MACsec encryption of their secure channel through pass through device 502.

It may be appreciated that if it is determined that MACsec pass through should not be enabled, if the MACsec pass through feature is enabled, then the feature may be disabled based on the determination. It may be determined that the MACsec feature should not be enabled if either the first neighbor network device or the second neighbor network device is not MACsec capable.

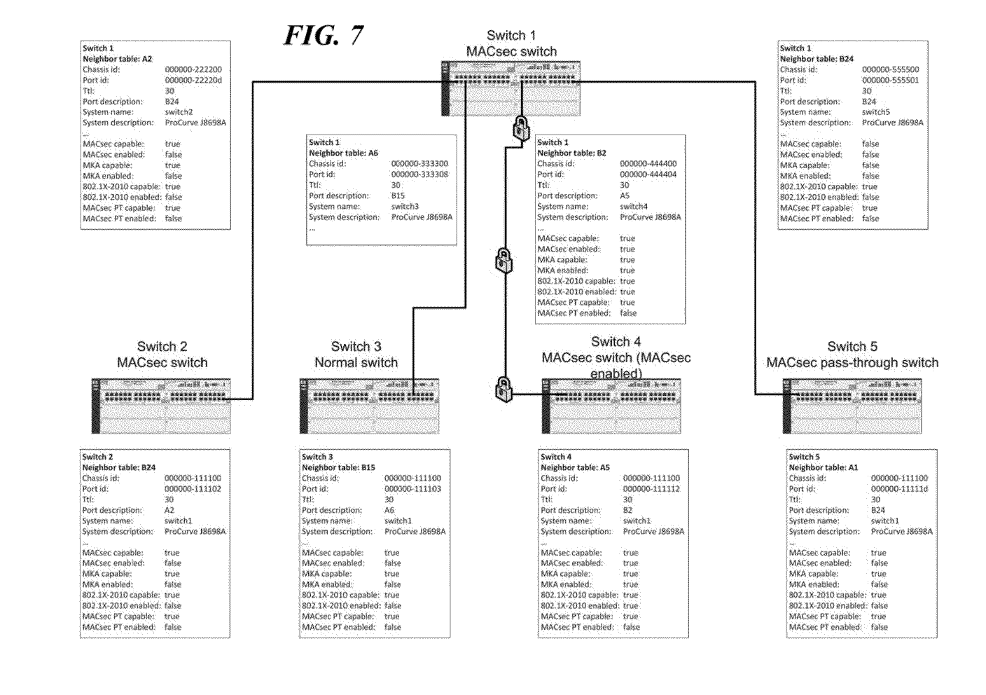

FIG. 7 depicts a system diagram of several network devices. In this example, the network devices are implemented as switches having varying features. It may be appreciated that each of the switches depicted in FIG. 7 may be implemented similarly to the network device as discussed with regard to FIG. 1, As can be seen in FIG. 7, switch 1 is connected, at port A2 to switch 2. Switch 1 is connected, at port A6 to switch 3. Switch 1 is connected, at port B2 to switch 4. Switch 1 is connected, at port B24 to switch 5.

At switch 1, a neighbor network device table is stored for each of the network devices that switch 1 is connected to at each of switch 1's ports. Neighbor tables include information associated with the port of the neighbor network device that the switch is connected to For example, a neighbor table for port A2 is stored at switch 1 for information relating to the port that switch 1 is connected to at switch 2. A neighbor table for port A6 is stared at switch 1 and includes information relating to the port that switch 1 is connected to at switch 3. A neighbor table for port B2 is stored at switch 1 and includes information relating to the port that switch 1 is connected to at switch 4. A neighbor table for port B24 is stored at switch 1 and includes information relating to the port that switch 1 is connected to at switch 5.

Similarly, switches 2, 3, 4 and 5 store a local neighbor table for ports B24, B15, A5 and A1 respectively, including information associated with the respective ports A2, A6, B2 and B24 at switch 1 that each of witches 2, 3, 4 and 5 are connected to.

When a discovery message is received at a port of a network device, the message may be parsed and information related to one or more attributes may be extracted and stored in the appropriate neighbor table. As can be seen in FIG. 7, switch Is neighbor table at port A2 indicates that port B24 at switch 2 is MACsec capable but disabled. MKA capable but disabled, 802.1X-2010 capable but disabled, and MACsec pass through capable, but disabled.

As can be further seen in FIG. 7, switch 2's neighbor table at port B24 indicates that port A2 at switch 1 is MACsec capable but disabled, MKA capable but disabled, 802.1X-2010 capable but disabled, and MACsec pass through capable, but disabled.

Assuming, for example, that switch 2 is a new device to be added to the system in FIG. 7, the process depicted in FIG. 4 may be implemented in order to automatically enable a feature at switch 2. Similarly, the process depicted in FIG. 4 may be implemented at switch 1 in order to automatically enable the same feature at switch 1. In other words, based on the discovery message, switch 1 and switch 2 may learn about similar features capable at the respective ports the devices are connected to and automatically enable the features.

The following describes the pass through feature that may be enabled at a network device as discussed above. The pass through feature is described with respect to MACsec. The MACsec standard provides for devices to establish secure connections to provide information from one device to another. While typically, without the direct connection, a MACsec secure association does not form, by providing an intermediate device with a pass through feature, secure communication may be established between two network devices. This pass through feature was discussed, for example, with respect to FIG. 5.

In one embodiment, the pass though feature can include ignoring 802.1X frames and/or MACsec packets with an Ethertype indicating a MACsec. In certain scenarios, 802.1X frames may include an Ethertype of 0x888E while MACsec frames may include an Ethertype of 0x88E5. For a consumer, a pass through capable device could be cheaper to use compared to a MACsec compliant device because MACsec hardware can add to unit costs.

This is contrary to the 802.1 standard, which states that all Bridge Protocol Data Units (BPDUs) such as 802.1X frames shall be consumed by the receiving network device (e.g., switch). In this scenario, the intermediary network switch would go against the approach of the standard and forward the 802.1X protocol packets to the next device in a chain to the destination device. If a MACsec client sends an 802.1X protocol packet, the MACsec pass through network device will ignore the packet and forward it on to the next device, the end device being, a MACsec device, such as a MACsec switch. The MACsec switch can then respond to the client and the intermediary network device will ignore the 802.1X protocol packets being used to communicate between the MACsec compatible devices. This exchange allows the MACsec enabled devices to negotiate the necessary information to form a secure channel with one another. In certain embodiments, once the secure channel is formed, the intermediary network device no longer inspects any of the traffic sent between the MACsec devices. Multiple pass through network devices can be used in the path between two MACsec compatible end devices.

In certain scenarios, Ethertype is a two-octet field in an Ethernet frame. It is used to indicate which protocol is encapsulated in the payload of the Ethernet frame. In modem applications, Ethertype generally starts at 0x0800. As further detailed below, Ethertype can be placed in an Ethernet frame after a destination MAC address and a Source MAC address. in certain embodiments, a list of Ethertypes may be stored at the pass through switch that can be used to determine which frames are passed through. MACsec frames and 802.1X frames can be on the list. Further, the list can be preset in firmware and/or variable based on user input.

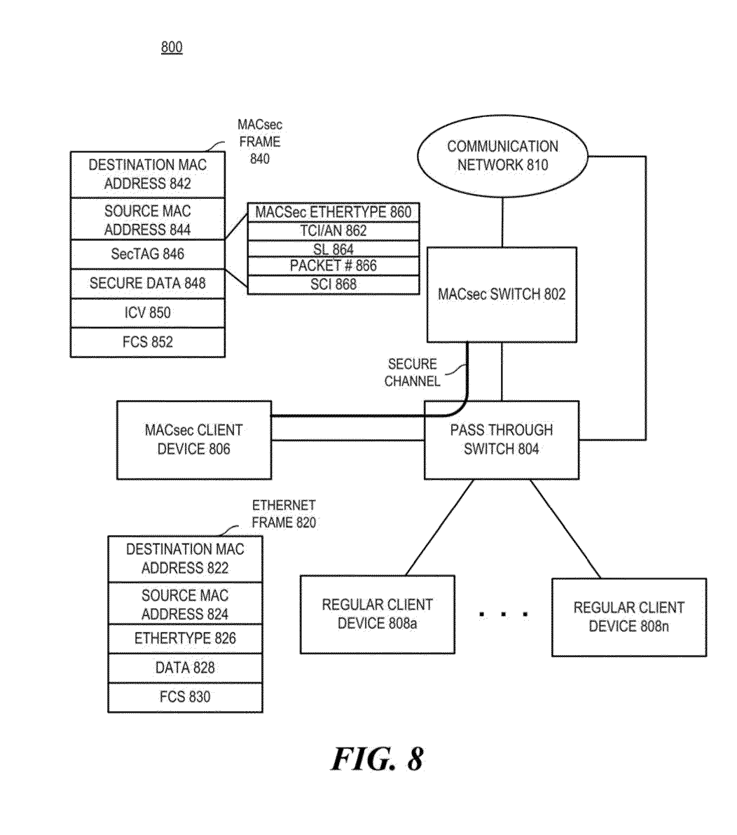

FIG. 8 is a block diagram of a system including a pass through switch capable of passing frames based on an Ethertype, according to one example. The system 800 can include a MACsec Switch 802, a pass through switch 804, a MACsec client device 806 or multiple MACsec client devices, one or more regular client devices 808a-808n, and/or other devices connected via a communication network 810, In certain examples, the MACsec client device 806, the regular client devices 808a-808n, or other devices connected via the communication network 810 are computing devices, such as servers, client computers, desktop computers, mobile computers, etc. Further, in certain embodiments, the MACsec switch 802, the pass through switch 804, the MACsec client device 806, and the regular client devices 808 can be implemented, at least in part, via a processing element, memory, and/or other components.

In one example, client devices such as the MACsec client device 806 and/or regular client device 808 can use a standard Ethernet frame, such as Ethernet frame 820, as a packet to communicate to other devices. Ethernet frame 820 includes a destination MAC address 822 that describes the MAC address of the intended recipient, a source MAC address 824 that describes the MAC address of the sender of the Ethernet frame 820, an Ethertype 826, payload data 828, and a frame check sequence (FCS) 830 that can be used for error detection. In certain scenarios, when connections are made between a regular client device 808 and another device via the pass through switch 804, the regular client device 808 can be authenticated, for example, at the access level, by the pass through switch 804.

Further, the MACsec client device 806 can use one or more types of frames to communicate with other devices, for example, a standard Ethernet frame 820 or a MACsec frame 840. The MACsec frame 840 can include a destination MAC address 842, a source MAC address 844, a security tag (SecTAG) 846, secure data 848 that includes encrypted data, an integrity check value (ICV) 850 that can be calculated based on the contents of the frame, and an FCS 852. The SecTAG 846 can include a MACsec Ethertype 860, tag control information/association number (TCI/AN) 862 including information that may be used to determine a version of the MACsec protocol to be used in the packet and may include information that can be used to transmit the frame over a secure channel, a short length (SL) 864 that can be used to determine the number of bytes of the secure data 848 that is between the last byte of the of the SecTAG 846 and the first byte of the ICV 850, a packet number 866, and a Secure Channel Identifier 868 that can be used to identify a source address and port that transmitted the frame. In this example, the MACsec Ethertype 860 is directly after the source MAC address 844. As such, the Ethertype is in the same location in the MACsec Frame 840 and the Ethernet Frame 820.

In one example, the MACsec client device 806 wishes to connect to another MACsec enabled device via the pass through switch 804. In this example, the communication can be processed via the MACsec switch 802. The MACsec client device 806 can perform 802.1X authentication with the MACsec switch 802 via the pass through switch 804. In this scenario, the pass through switch 804 receives one or more 802.1X frames from the MACsec client device 806 and parses the frames to determine that the frames should be passed through the pass through switch 804. The frames are not consumed by the pass through switch 804, which goes against the 802.1X specification. The decision to pass through the switch can be based on the Ethertype of the frame. In one scenario, an 802.1X protocol frame has the Ethertype of 0x888E. This Ethertype can be configured to be passed through the pass through switch 804 to another device. In certain scenarios, the MACsec switch 802 can be directly connected to the pass through switch 804 and can use the 802.1X frame, In other scenarios, multiple pass through switches can be connected between the MACsec devices. Each of the pass through switches can be configured to pass through 802.1X frames. An exchange can occur between the two MACsec compatible devices (e.g., the MACsec client device 806 and the MACsec switch 802) for the authentication. Each of the 802.1X frames to/from the MACsec compatible devices are passed through. As such, a secure association can be created between the MACsec compatible devices. This can be enabled by the pass through switch 804 and/or other pass through switches in between the MACsec compatible devices passing through the pass through switches.

Once the secure association is made, MACsec frames can be sent to/from the MACsec compatible devices. These frames can include secure data The pass through switch 604 can parse frames received to determine the Ethertype. If the Ethertype indicates that the frame is a MACsec frame, for example, if the frame has an Ethertype of 0x88E5, the pass through switch 804 can pass the frame to the next device in the path between MACsec compatible devices. In one example, the next device is another pass through switch between the MACsec devices. In another example, the next device is a MACsec compatible device, such as MACsec client device 806 or MACsec switch 802. In certain embodiments, passing through the frames means that the frames are forwarded to the next device without alteration. In certain embodiments, without alternation means that the frame forwarded is the same, bit by bit, as the frame.

At this stage, in certain examples, the pass through switch 804 has no visibility to the payload of the client traffic. As such, the pass through device does not perform any enforcement at the access layer. This type of enforcement can include, for example, Access Control Lists (ACLs), Quality of Service (QoS), and other filtering policies based on contents other than MAC address In certain examples, any such filtering policies can be performed at a MACsec compatible device, such as MACsec switch 802. As noted above, this type of access control can be implemented by the pass through switch 804 when other frames are received, for example, frames not associated with Ethertypes that are associated with a pass through list.

Thee communication network 810 can use wired communications, wireless communications, or combinations thereof. Further, the communication network 810 can include multiple sub communication networks such as data networks, wireless networks, telephony networks, etc. Such networks can include, for example, a public data network such as the Internet, local area networks (LANs), wide area networks (WANs), metropolitan area networks (MANS), cable networks, fiber optic networks, combinations thereof, or the like. In certain examples, wireless networks may include cellular networks, satellite communications, wireless LANs, etc. Further, the communication network 810 can be in the form of a direct network link between devices (e.g., MACsec switches, pass through switches, other switches, routers, etc.). Various communications structures and infrastructure can be utilized to implement the communication network(s).

By way of example, the MACsec client device 806, regular client devices 808, pass through switches, MACsec switches, etc. communicate with each other and other components with access to the communication network 810 via a communication protocol or multiple protocols. A protocol can be a set of rules that defines how nodes of the communication network 810 interact with other nodes. Further, communications between network nodes can be implemented by exchanging discrete packets of data or sending messages. Packets can include header information associated with a protocol (e.g., information on the location of the network node(s) to contact) as well as payload information.

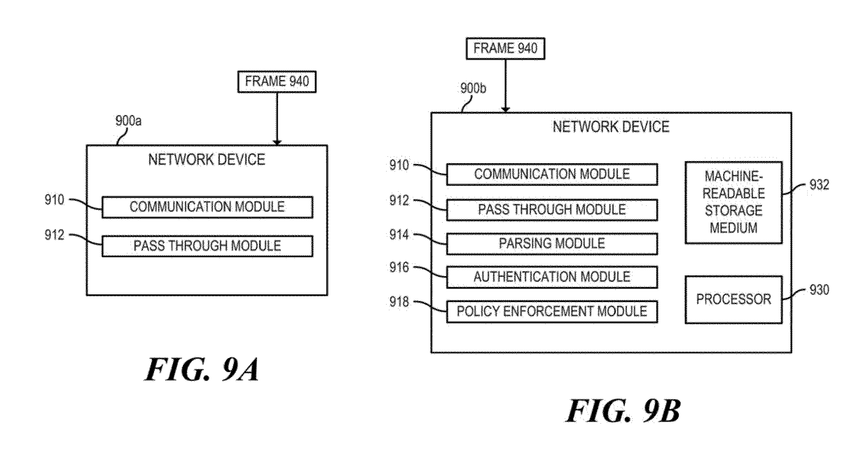

FIGS. 9A and 9B are block diagrams of network devices 900a. 900b capable of passing through frames based on an Ethertype associated with the respective frames, according to various examples. The respective network devices 900a, 900b may be a switch, a router, a bridge, or any other computing device that receives, processes and/or forwards packets and/or frames. It may be appreciated that network devices 900a and 900b may further include the modules as discussed with regard to FIG. 1. In another example, pass through switch 804 can be considered a network device. As shown in FIG. 9A, the network device 900a can include a communication module 910 and a pass through module 912. Further, in certain examples, the network device 900b can also include a parsing module 914, an authentication module 916, a policy enforcement module 918, a processor 930, and a machine-readable storage medium 932.

As discussed in reference to system 800, the network device 900 can receive frames 940 from a connected device (e.g., a regular client device 908, a MACsec client device 906, a MACsec switch 902, another network device, etc.). A communication module 910 of the network device 900 receives a frame 940. As noted above, the frame can include a first header portion associated with a destination MAC address followed by a second header portion associated with a source MAC address, which is followed by a third header portion that is associated with an Ethertype. Examples of such frames include MACsec frame 840 and Ethernet frame 820. A MACsec frame can be associated with a 0x88E5 Ethertype. In some examples, a frame can include a protocol packet, such as an 802.1X frame. In some embodiments, a protocol packet is a frame that is associated with a set of digital system message rules, such as 802.1X. As noted above, 802.1X frames may be associated with a particular Ethertype, for example, 0x888E.

The parsing module 914 can perform a syntactic analysis to analyze the header portions to determine the Ethertype of the frame 940. Further, the pass through module 912 can determine whether to pass the frame to another device (e.g., a MACsec client device, a MACsec switch, another pass through device in the path to another MACsec compatible device, etc.) based on the Ethertype. In certain embodiments, the passing of the frame is done without modification of the frame. As noted above, in one example, the pass through module 912 determines to pass the frame if the Ethertype reflects an associated protocol frame (e.g., an 802.1X frame with an Ethertype of 0x888E) or a frame with secure data (e.g., a MACsec frame with an Ethertype of 0x88E5). In certain embodiments, these Ethertypes can be associated with a list. If the Ethertype matches an Ethertype on the list, the frame is passed. In other embodiments, the Ethertype determination can be hard coded.

In one example, client device sends a standard Ethernet frame. The communication module 910 receives the frame and parses the frame. The Ethertype reflects a packet that is associated with another protocol than ones on the list. As such, the pass through module 912 does not merely pass the frame to the next device on its path. Instead, the network device 900 can use an authentication module 916 to perform an access layer authentication for the device associated with the frame. Further, the policy enforcement module 918 can perform enforcement of policies at the access layer (e.g., filtering, use of QoS, etc.).

In another example, a MACsec client sends an 802.1X frame to initiate a secure channel to another MACsec device, for example, a MACsec switch. The frame is received at the communication module 910. The pass through module 912 determines that the frame is to be passed based on its Ethertype. As such, the pass through module 912 can cause the communication module 910 to send the unaltered frame to the MACsec device. 802.1X frames can be passed through the network device 900 in this manner to create a secure connection between the MACsec devices.

Then, the MACsec client can send a MACsec frame to the other MACsec device. The communication module 910 can receive the frame and the pass through module 912 can determine that the frame should be passed through based on the Ethertype. In this scenario, access layer authentication of 802.1X packets and/or access layer validation of MACsec frames is not performed at the network device 900. However, access layer authentication or validation may be performed at an associated MACsec switch. As such, MACsec frames can pass through the network device 900 on their way to/from the MACsec devices. In certain embodiments, access layer authentication can include 802.1X authentication that validates that a client has valid credentials and/or is allowed on the network. After a successful authentication, 802.1X can also be used to perform a MACsec Key Agreement (MKA) negotiation between MACsec devices to obtain symmetric keys used for MACsec encryption of their secure channel. Encrypted MACsec frames can be validated using the ICV at the MACsec devices.

A processor 930, such as a central processing unit (CPU) or a microprocessor suitable for retrieval and execution of instructions and/or electronic circuits can be configured to perform the functionality of any of the modules 910, 912, 914, 916 described herein. The processor 930 can also be a special purpose networking processor. In certain scenarios, instructions and/or other information, such as an Ethertype list, a buffer, a cache, etc. can be included in machine-readable storage medium 932 or other memory. Moreover, in certain embodiments, some components can be utilized to implement functionality of other components described herein.

Each of the modules 910-916 may include, for example, hardware devices including electronic circuitry for implementing the functionality described herein. In addition or as an alternative, each module 910-916 may be implemented as a series of instructions encoded on a machine-readable storage medium 932 of network device 900 and executable by processor 930. It should be noted that, in some embodiments, some modules are implemented as hardware devices, while other modules are implemented as executable instructions.

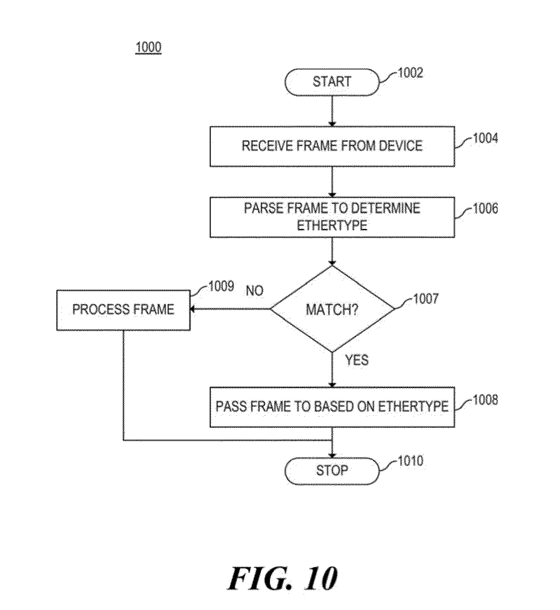

FIG. 10 is a flowchart of a method for forwarding a frame based on an Ethertype, according to one example. Although execution of method 1000 is described below with reference to network device 900, other suitable components for execution of method 1000 can be utilized (e.g., pass through switch 804). Additionally, the components for executing the method 1000 may be spread among multiple devices. Method 1000 may be implemented in the form of executable instructions stored on a machine-readable storage medium such as storage medium 932, and/or in the form of electronic circuitry.

Method 1000 may start at 1002 and proceed to 1004 a communication module 910 of the network device 900 receives a frame from a client device (e.g., regular client device 808, MACsec client device 806, etc.). The frame can include a first header field including a destination MAC address followed by a second header field including a source MAC address, followed by a third header field including an Ethertype. Examples of such a header include MACsec frame 840 and Ethernet frame 820. As such, the frame can be a standard MACsec frame, a standard Ethernet frame, a frame compliant with the 802.1X specification, etc

A parsing module 914 of the network device 900 then parses the frame to determine the Ethertype (1006). Then, the frame can be passed or forwarded to a second device based on whether the Ethertype matches an Ethertype that should be passed (1007). In one example, at 1008, the frame is forwarded if the frame has an Ethertype that reflects a MACsec frame (e.g., 0x88E5) or an 802.1X frame (e.g., 0x888E). The second device can be a secure device such as a MACsec device like MACsec switch 802. In certain examples, the frame can reach the second secure device via other pass through devices, if the Ethertype does not match an Ethertype that should be passed through, at 1009, the network device 900 can process the frame. Then, at 1010, the method 1000 can stop. The network device 900 can continue other functionality, for example, processing another frame from one of the devices.

What is claimed is:

1. A non-transitory computer-readable storage medium, storing a set of instructions, executable by a processor, to perform a method to:
generate, at a network device, a discovery message, the discovery message including information related to a security attribute of a port of the network device;
transmit the generated message to a neighbor network device;
receive a response to the discovery message, the response to the discovery message including information related to the security attribute of a port of the neighbor network device; and
determine whether to enable/disable a security feature at the port of the network device based on the information related to the security attribute of the port of the neighbor network device.

2. The non-transitory computer-readable storage medium of claim 1, the method further to:
enable a security feature at the port of the network device when it is determined that the port of the network device and the port of the neighbor network device are both capable of enabling the security feature.

3. The non-transitory computer readable storage medium of claim 2, the method further to:
transmit a communication to the neighbor network device securely based on the enabled security feature.

4. The non-transitory computer readable storage medium of claim 1, wherein the information related to the security attribute includes whether the port of the network device is capable of enabling the security feature related to the security attribute and whether the security feature is enabled.

5. The non-transitory computer-readable storage medium of claim 1, wherein the security feature is one of MAC security standard (MACsec) and 802.1x port-based encryption.

6. The non-transitory computer-readable storage medium of claim 1, wherein the discovery message is generated in accordance with one of link layer discovery protocol and a physical layer device (PHY) communication exchange.

7. A network device, comprising:
a discovery module to
generate discovery messages, the discovery messages to include information related to an attribute of a port of the network device;
parse received discovery messages for information related to the attribute of a port of a neighbor network device; and
determine whether to enable/disable a feature at the port of the network device based on the information related to the attribute of the port of the neighbor network device;
a feature module to enable/disable a feature at a port of the network device based on a determination of the discovery module to enable the feature; and
a processor to implement the discovery module.

8. The network device of claim 7, further comprising:
a pass through module to pass information through the port of the network device without modification of a frame, based on Ethertype, when a pass through feature is enabled.

9. The network device of claim 8, the discovery module further to:
receive and parse discovery messages for information related to the attribute of a port of another neighbor network device;
determine whether to enable/disable the pass through feature at the port of the network device based on the information related to the attribute of the port of the neighbor network device and the attribute of the port of the another neighbor network device, wherein the attribute relates to a security feature.

10. The network device of claim 7, wherein the feature is MAC security standard (MACsec).

11. The network device of daim 7, wherein the feature is 802.1X port-based encryption.

12. The network device of claim 7, wherein the discovery message is generated in accordance with one of link layer discovery protocol and a physical layer device (PHY) communication exchange.

13. A computer-readable storage medium, storing a set of instructions, executable by a processor, to perform a method to:
receive, at a port of a network device, a discovery message from a port of a first neighbor network device, the discovery message including information related to a security attribute of the port of the first neighbor network device;
determine, based on the received information related to the security attribute, whether the port of the first neighbor network device is capable of enabling a security feature;
determine whether a port of a second neighbor network device is capable of enabling the security feature; and
enabling a pass through feature at the port of the network device to enable secure communication between the port of the first neighbor device and the port of the second neighbor device based on a determination that the port of the first neighbor network device and the port of the second neighbor network device are capable of enabling a security feature.

14. The computer-readable storage medium of claim 13, wherein to determine whether the port of the second neighbor network device is capable of enabling the security feature includes:
transmit to the second neighbor network device a discovery message;
receive a discovery message from the second neighbor network device including information related to the security attribute of the port of the second neighbor network device.

15. The computer readable storage medium of claim 13, wherein the pass through feature permits secure communication using 802.1X between the port of the first neighbor network device and the port of the second neighbor network device.

16. The computer readable storage medium of claim 13, wherein the pass through feature permits secure communication using MAC security standard between the port of the first neighbor network device and the port of the second neighbor network device.
